(19) United States
(12) Patent Application Publication
(10) Pub. No.: US 2015/0098370 A1
(43) Pub. Date: Apr. 9, 2015

(54) Method of Handling HARQ Resource for FDD Carrier and Related Communication Device

(71) Applicant: Industrial Technology Research Institute, Hsinchu (TW)

(72) Inventor: Chien-Min Lee, New Taipei City (TW)

(21) Appl. No.: 14/493,359

(22) Filed: Sep. 23, 2014

Related U.S. Application Data
(60) Provisional application No. 61/886,671, filed on Oct. 4, 2013.

(51) Int. Cl. H04L 1/16; H04W 72/04; H04L 5/00; H04L 1/18; H04L 5/14

(52) U.S. Cl. CPC H04L 1/1671; H04L 1/1861; H04L 5/14; H04L 5/0053; H04W 72/0413
USPC 370/280; 370/281

(57) ABSTRACT

A method of determining hybrid automatic repeat request (HARQ) resource of a uplink (UL) subframe of a frequency-division duplexing (FDD) carrier for an advanced communication device comprises determining an association index according to an operation of the FDD carrier; determining a new association set according to the association index and an association set of the UL subframe of a UL/downlink (UL/DL) configuration; and determining the HARQ resource of the UL subframe according to the association index and the new association set.

### CROSS REFERENCE TO RELATED APPLICATIONS

This application claims the benefit of U.S. Provisional Application No. 61/886,671, filed on Oct. 4, 2013 and incorporated herein by reference.

### BACKGROUND OF THE INVENTION

1. Field of the Invention

The present invention relates to a method used in a wireless communication system and related communication device, and more particularly, to a method of handling hybrid automatic repeat request (HARQ) resource for a frequency-division duplexing (FDD) carrier and related communication device.

2. Description of the Prior Art

A long-term evolution (LTE) system supporting the 3rd Generation Partnership Project (3GPP) Rel-8 standard and/or the 3GPP Rel-9 standard are developed by the 3GPP as a successor of the universal mobile telecommunication system (UMTS) for further enhancing performance of the UMTS to satisfy increasing needs of users. The LTE system includes a new radio interface and a new radio network architecture that provides high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple user equipments (UEs), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint (CoMP) transmissions/reception, uplink (UL) multiple-input multiple-output (UL-MIMO), etc. For a UE and an eNB to communicate with each other in the LTE-A system, the UE and the eNB must support standards developed for the LTE-A system, such as the 3GPP Rel-10 standard or later versions.

Different from the LTE/LTE-A system operating in a frequency-division duplexing (FDD) mode (or simply FDD system), transmission directions of subframes of a frequency band in the LTE/LTE-A system operating in a time-division duplexing (TDD) mode (or simply TDD system) may be different. That is, the subframes in the same frequency band are divided into UL subframes, downlink (DL) subframes and special subframes according to the UL/DL configuration specified in the 3GPP standard.

FIG. 1 is a table 102 of the UL/DL configurations with subframes and corresponding directions. In FIG. 1, 7 UL/DL configurations are shown, wherein each of the UL/DL configurations indicates a set of transmission directions (hereinafter, directions, for short) for 10 subframes, respectively. Each subframe is indicated with a corresponding subframe number (i.e., subframe index) in FIG. 1. In detail, “U” represents that the subframe is a UL subframe where UL data is transmitted, and “D” represents that the subframe is a DL subframe where DL data is transmitted. “S” represents that the subframe is a special subframe where control information and maybe data (according to the special subframe configuration) is transmitted, and the special subframe can also be seen as the DL subframe in the prior art. Note that the eNB may configure a UL/DL configuration to a UE via a higher layer signaling (e.g., System Information Block Type 1 (SIB1)) or a physical layer signaling (e.g., DL control information (DCI)).

An advanced UE which may be a half-duplex UE (or a UE operating in the half-duplex mode) may be configured with a TDD carrier and a FDD carrier, while a legacy UE may be configured with only the FDD carrier. In this situation, a collision of HARQ resources may occur if the advanced UE and the legacy UE intend to transmit HARQ feedbacks in a same UL subframe of the FDD carrier. The collision may occur because the advanced UE and the legacy UE transmit the HARQ feedbacks by using overlapped HARQ resource (e.g., the same HARQ resource) in the UL subframe, because rules for transmitting the HARQ feedbacks followed by the advanced UE and the legacy UE may be different. The network cannot detect the HARQ feedbacks transmitted by the advanced UE and the legacy UE. Communications between the network and the legacy UE and the advanced UE cannot proceed regularly.

Thus, how to solve the collision of the HARQ resources occurred when the advanced UE and the legacy UE operate in the same FDD carrier is an important topic to be discussed.

### SUMMARY OF THE INVENTION

The present invention therefore provides a method and related communication device for handling HARQ resources for the FDD carrier to solve the abovementioned problem.

A method of determining hybrid automatic repeat request (HARQ) resource of a uplink (UL) subframe of a frequency-division duplexing (FDD) carrier for an advanced communication device comprises determining an association index according to an operation of the FDD carrier; determining a new association set according to the association index and an association set of the UL subframe of a UL/downlink (UL/DL) configuration; and determining the HARQ resource of the UL subframe according to the association index and the new association set.

A method of determining hybrid automatic repeat request (HARQ) resource of a uplink (UL) subframe of a frequency-division duplexing (FDD) carrier for an advanced communication device comprises determining a starting point of a resource region corresponding to a new association set, wherein the resource region corresponding to the new association set is different from a resource region corresponding to an association index determined according to an operation of the FDD carrier; determining that the new association set is an association set of the UL subframe of a UL/downlink (UL/DL) configuration; and determining the HARQ resource of the UL subframe according to the new association set.

A communication device comprises a storage unit for storing instructions of determining an association index according to an operation of the FDD carrier; determining a new association set according to the association index and an association set of the UL subframe of a uplink/downlink (UL/DL) configuration; and determining the HARQ resource of the UL subframe according to the association index and the new association set; and a processor, coupled to the storage unit, configured to execute the instructions stored in the storage unit.

A communication device comprises a storage unit for storing instructions of determining a starting point of a resource region corresponding to a new association set, wherein the resource region corresponding to the new association set is different from a resource region corresponding to an association index determined according to an operation of the FDD carrier; determining that the new association set is an association set of the UL subframe of a UL/downlink (UL/DL) configuration; and determining the HARQ resource of the UL subframe according to the new association set; and a processor, coupled to the storage unit, configured to execute the instructions stored in the storage unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a table of the UL/DL configurations with subframes and corresponding directions.

FIG. 2 is a schematic diagram of a wireless communication system according to an example of the present invention.

FIG. 3 is a schematic diagram of a communication device according to an example of the present invention.

FIG. 4 is a flowchart of a process according to an example of the present invention.

FIG. 5 is a table of association sets according to an example of the present invention.

FIG. 6 is a table of association sets according to an example of the present invention.

FIGS. 7-9 are schematic diagrams of association sets of the advanced UE and the legacy UE according to examples of the present invention.

FIG. 10 is a schematic diagram of resource regions according to an example of the present invention.

FIG. 11 is a flowchart of a process according to an example of the present invention.

FIGS. 12-13 are schematic diagrams of association sets of the advanced UE and the legacy UE according to examples of the present invention.

FIG. 14 is a schematic diagram of resource regions according to an example of the present invention.

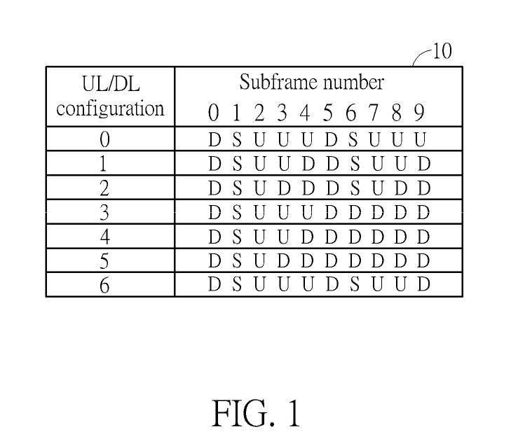

### DETAILED DESCRIPTION

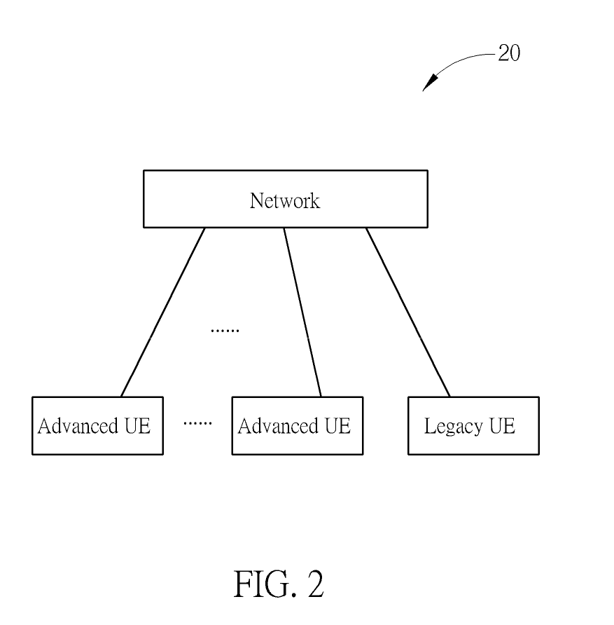

Please refer to FIG. 2, which is a schematic diagram of a wireless communication system 20 according to an example of the present invention. The wireless communication system 20 is briefly composed of a network, advanced user equipments (UEs) (i.e., advanced communication devices) and a legacy UE (i.e., legacy communication device). The wireless communication system 20 may support a frequency-division duplexing (FDD) mode and/or a time-division duplexing (TDD) mode, e.g., supports a FDD carrier and/or a TDD carrier. That is, the network and the UEs may communicate with each other by using uplink (UL) subframes and downlink (DL) subframes of the TDD carrier according to a UL/DL configuration of the TDD carrier, when the TDD carrier is configured to the UEs. In addition, the network and the UEs may communicate with each other by using UL subframes of a UL FDD carrier and/or DL subframes of a DL FDD carrier, when the FDD carrier(s) are configured to the UEs.

In FIG. 2, the network and the UEs are simply utilized for illustrating the structure of the wireless communication system 20. Practically, the network can be a universal terrestrial radio access network (UTRAN) comprising a plurality of Node-Bs (NBs) in a universal mobile telecommunications system (UMTS). Alternatively, the network can be an evolved UTRAN (E-UTRAN) comprising a plurality of evolved NBs (eNBs) and/or relays in a long term evolution (LTE) system, a LTE-Advanced (LTE-A) system or an evolution of the LTE-A system.

Furthermore, the network can also include both the UTRAN/E-UTRAN and a core network, wherein the core network includes network entities such as Mobility Management Entity (MME), Serving Gateway (S-GW), Packet Data Network (PDN) Gateway (P-GW), Self-Organizing Networks (SON) server and/or Radio Network Controller (RNC), etc. In other words, after the network receives information transmitted by a UE (advanced UE or legacy UE), the information may be processed only by the UTRAN/E-UTRAN and decisions corresponding to the information are made at the UTRAN/E-UTRAN. Alternatively, the UTRAN/E-UTRAN may forward the information to the core network, and the decisions corresponding to the information are made at the core network after the core network processes the information. In addition, the information can be processed by both the UTRAN/E-UTRAN and the core network, and the decisions are made after coordination and/or cooperation are performed by the UTRAN/E-UTRAN and the core network. A UE (advanced UE or legacy UE) can be a mobile phone, a laptop, a tablet computer, an electronic book or a portable computer system, but is not limited. In addition, the network and the UE can be seen as a transmitter or a receiver according to direction, e.g., for a UL, the UE is the transmitter and the network is the receiver, and for a DL, the network is the transmitter and the UE is the receiver. More specifically, for the network, the direction of the transmission is DL, and the direction of the reception is UL. For the UE, the direction of the transmission is UL, and the direction of the reception is DL.

The advanced UE may communicate with the network via multiple component carriers (CCs) (e.g., serving cells) with different modes. For example, the advanced UE may communicate with the network via two component carriers, wherein one of the component carriers is a FDD carrier and the other one of the component carrier is a TDD carrier. Further, the FDD carrier may be a UL carrier, and the TDD carrier may be a DL carrier. In another example, the FDD carrier may be a DL carrier, and the TDD carrier may be a UL carrier. In addition, the FDD carrier and the TDD may be managed (e.g., allocated, arranged) by the same network entity (e.g., the same eNB) where an ideal backhaul is possible, or may be managed by different network entities where a nonideal backhaul is possible. In another example, both of the carriers may be FDD carriers. The advanced UE may know the mode operated by the legacy UE. For example, the advanced UE may know that the legacy UE operates in the FDD mode, i.e., communicates with the network via a FDD carrier. The advanced UE may refer to a communication device supporting the 3rd Generation Partnership Project (3GPP) Rel-11 standard or later versions. However, a legacy UE may also have functions similar to those supported by the advanced UE via an update, and the legacy UE belongs to an advanced UE in this situation. Preferably, the advanced UE may a half-duplex device. In certain situations, the advanced UE may perform both cellular communication (e.g., with the network) and device-to-device (D2D) communication (e.g., with another D2D device).

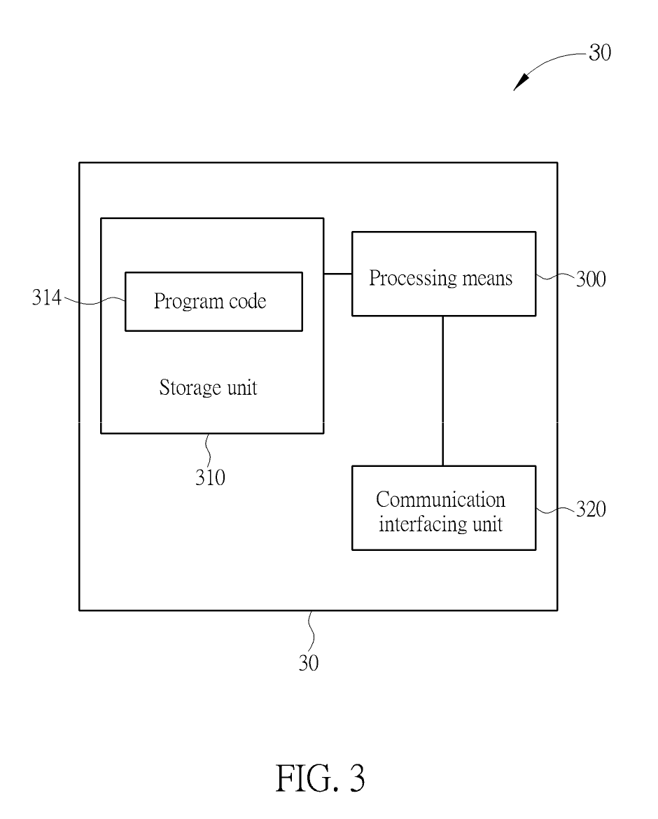

Please refer to FIG. 3, which is a schematic diagram of a communication device 30 according to an example of the present invention. The communication device 30 can be an advanced UE, the legacy UE and/or the network shown in FIG. 2, but is not limited herein. The communication device 30 may include a processing means 300 such as a microprocessor or Application Specific Integrated Circuit (ASIC), a storage unit 310 and a communication interfacing unit 320. The storage unit 310 may be any data storage device that can store a program code 314, accessed and executed by the processing means 300. Examples of the storage unit 310 include but are not limited to a subscriber identity module (SIM), read-only memory (ROM), flash memory, random-access memory (RAM), CD-ROM/DVD-ROM/BD-ROM, magnetic tape, hard disk, optical data storage device, non-volatile storage unit, non-transitory computer-readable medium (e.g., tangible media), etc. The communication interfacing unit 320 is preferably a transceiver and is used to transmit and receive signals (e.g., messages or packets) according to processing results of the processing means 300.

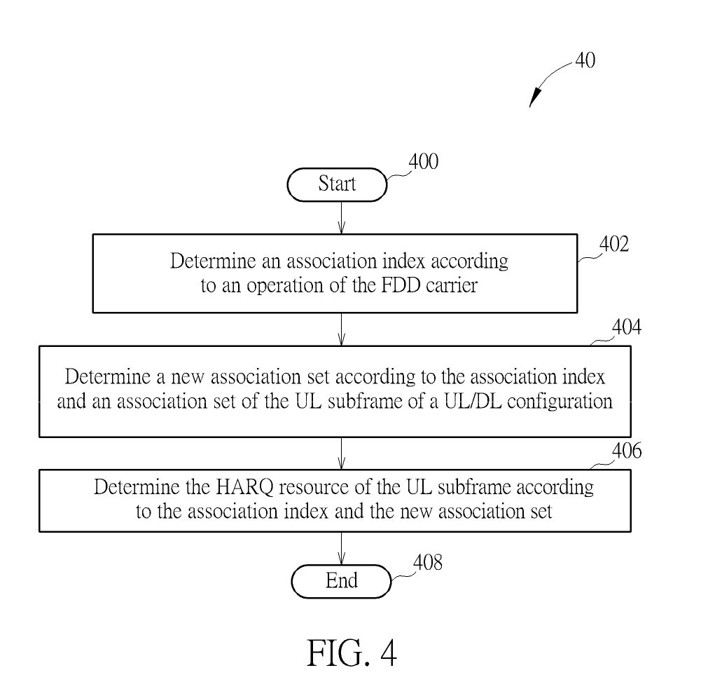

Please refer to FIG. 4, which is a flowchart of a process 40 according to an example of the present invention. The process 40 is utilized in an advanced UE shown in FIG. 2, for determining hybrid automatic repeat request (HARQ) resource of a UL subframe of a FDD carrier. The process 40 may be compiled into the program code 314 and includes the following steps:

Step 400: Start.

Step 402: Determine an association index according to an operation of the FDD carrier.

Step 404: Determine a new association set according to the association index and an association set of the UL subframe of a UL/DL configuration.

Step 406: Determine the HARQ resource of the UL subframe according to the association index and the new association set.

Step 408: End.

According to the process 40, the advanced UE determines an association index according to an operation of the FDD carrier. Then, the advanced UE determines a new association set according to the association index and an association set of the UL subframe of a UL/DL configuration. Thus, the advanced UE may transmit a HARQ feedback via the HARQ resource, to respond to at least one reception performed in at least one previous DL subframe of the FDD carrier. That is, the FDD carrier may be used by the advanced UE, or by both the advanced UE and the legacy UE. The advanced UE determines the HARQ resource according to both the UL/DL configuration and the operations of the FDD carrier, when the advanced UE intends to transmit the HARQ feedback via the FDD carrier. It should be noted that, the UL/DL configuration may correspond to a TDD carrier configured to the advanced UE, and the advanced UE may not be using the TDD carrier to communicate with the network when performing the process 40. In another example, the advanced UE may be using both the FDD carrier and the TDD carrier to communicate with the network, when performing the process 40. In another example, the UL/DL configuration may be configured by the network to the advanced UE via a higher layer signaling (e.g., radio resource control (RRC) signaling). Thus, collision of the HARQ resources is solved, and the advanced UE can mitigate effects to operations (e.g., transmission and/or reception) of the legacy UE. As a result, both the advanced UE and the legacy UE can operate regularly.

Methods according to which the process 40 is realized are not limited to the above description. For example, the association index may not overlap with the new association set. That is, the association index is different from association indices in the new association set. A resource region corresponding to the association index may not overlap with a resource region corresponding to the new association set. For example, a starting point of a resource region corresponding to the new association set may be at least determined according to a value configured by a higher layer signaling (e.g., RRC signaling). In another example, a starting point of a resource region corresponding to the new association set may be at least determined according to a maximum number of control channel elements (CCEs) of the FDD carrier. In another example, a starting point of a resource region corresponding to the new association set may be at least determined according to a total number of CCEs of another DL subframe in which a reception is performed and the reception triggers a HARQ feedback in the UL subframe. An interleaving may be performed on the new association set, e.g., resources corresponding to the association indices in the new association set are interleaved together. In addition, the legacy UE may be restricted to perform a reception in a DL subframe of the FDD carrier, and the DL subframe corresponds to the UL subframe according to the operation of the FDD carrier. That is, the legacy UE may be restricted to perform reception(s) only in certain DL subframes (e.g., the DL subframes 1-3) of the FDD carrier, such that the legacy UE only needs to transmit a corresponding UL subframe. In other words, the UL subframe(s) in which the legacy UE may transmit the HARQ feedback is controlled. Thus, the advanced UE may only need to modify its operation in the UL subframes in which the legacy UE may transmit the HARQ feedback (s). In addition, the advanced UE may determine at least one sequence index corresponding to the association index and the new association set, respectively. Then, the advanced UE may determine the HARQ resource of the UL subframe according to the at least one sequence index, the association index and the new association set. In another example, the advanced UE may determine at least one sequence index corresponding to the new association set, respectively. Then, the advanced UE may determine the HARQ resource of the UL subframe according to the at least one sequence index and the new association set. Further, a set of the at least one sequence index corresponding to the new association set may be related to one of the at least one sequence index corresponding to the association index.

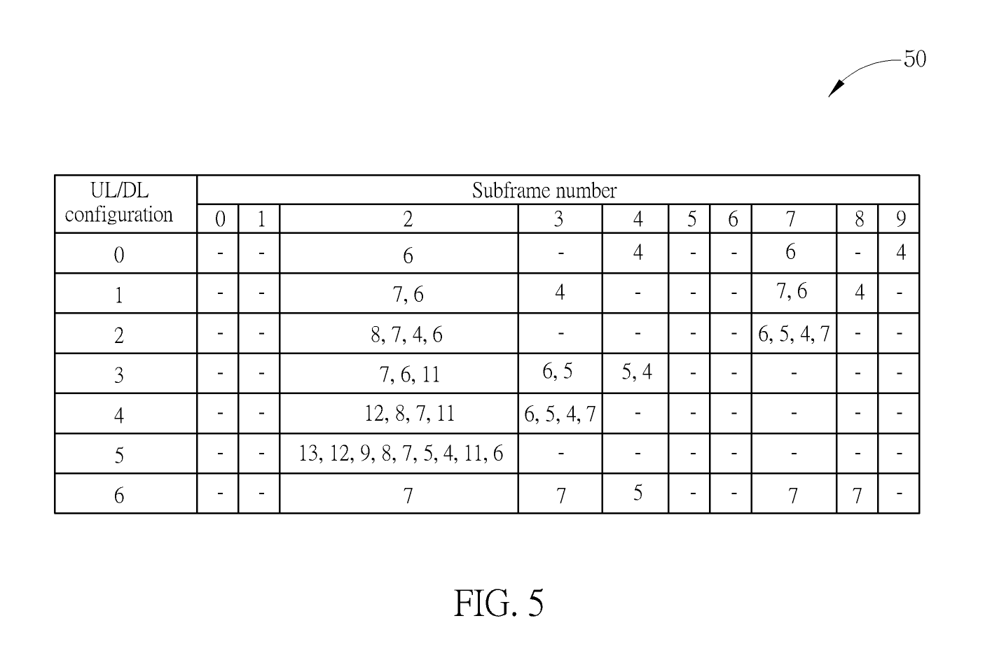

FIG. 5 is a table 50 of association sets according to an example of the present invention. The association sets for UL/DL configurations 0-6 and subframe indices 0-9 are shown in the table 50. Taking the subframe 2 and the UL/DL configuration 2 as an example, the association set is (8, 7, 4, 6), i.e., the association indices are 8, 7, 4 and 6. HARQ resource in the subframe 2 of a frame m is used for responding at least one reception occurred in subframes 4, 5, 8 and/or 6 of a frame (m−1). The reason is that distances between the subframe 2 of the frame m and the subframes 4, 5, 8 and 6 of the frame (m−1) are 8, 7, 4 and 6, respectively.

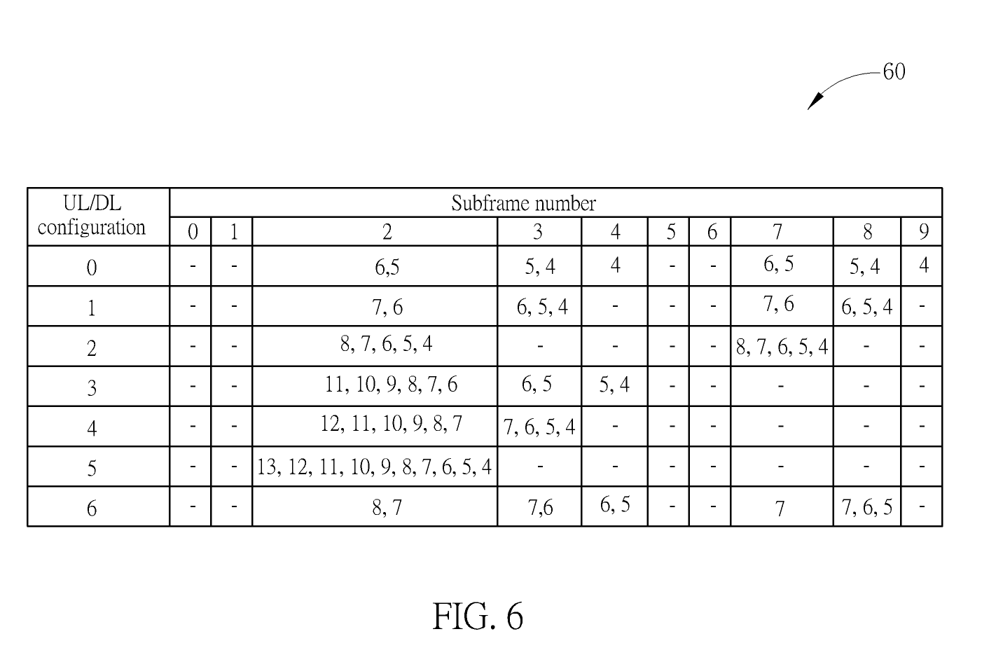

FIG. 6 is a table 60 of association sets according to an example of the present invention. Similar to those in the table 50, the association sets for UL/DL configurations 0-6 and subframe indices 0-9 are shown in the table 60. A method according to which the table 60 is used is the same as that for the table 50, and is not narrated herein.

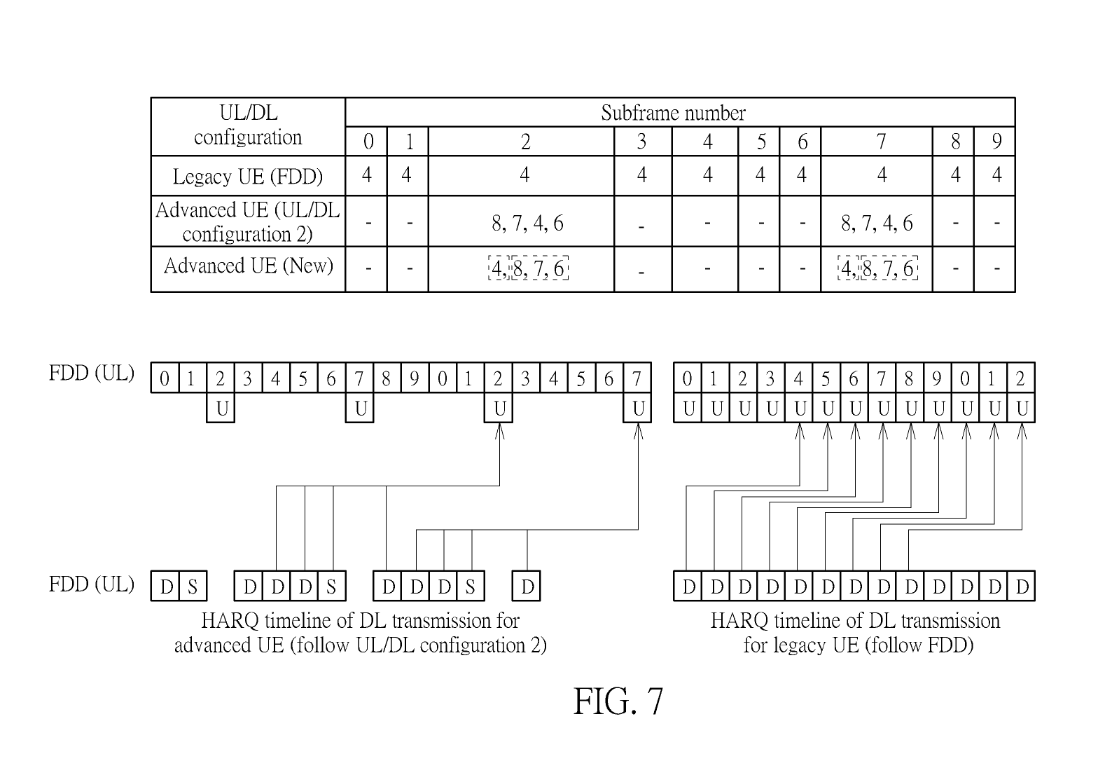

FIG. 7 is a schematic diagram of association sets of the advanced UE and the legacy UE according to an example of the present invention. In detail, the advanced UE and the legacy UE communicate with the network via a FDD carrier, and the advanced UE may be further configured with a UL/DL configuration 2 by the network for transmitting the HARQ feedback. Note that the FDD rule for transmitting the HARQ feedback is that a HARQ feedback is transmitted in a subframe (n+4) for responding to a reception performed in a subframe n. Thus, the association index for the FDD carrier is 4 for all subframes. Taking the subframe 2 of the FDD carrier as an example, the association set of the UL subframe 2 which includes the association set indices 8, 7, 4 and 6 will be used for determining HARQ resource, when the advanced UE intends to transmit a HARQ feedback in the subframe 2 of the FDD carrier. In addition, the HARQ feedback in the subframe 2 of the present frame m may be for responding to one or more DL receptions in DL subframes 4, 5, 8 and 6 of the previous frame (m−1) corresponding to the association set indices 8, 7, 4 and 6, respectively.

According to the process 40 and the above description, the advanced UE can determine that the association index is 4 according to the operation the FDD carrier, and can determine that the new association set is (8, 7, 6) according to the association index 4 and the association set (8, 7, 4, 6) of the UL subframe 2 of the UL/DL configuration 2. As can be seen, the new association set (8, 7, 6) does not overlap with the association index 4. In one example, the association index 4 may map to sequence index 0, and the association indices in the new association set (8, 7, 6) may map to sequence indices 0, 1, 2, respectively. Then, the advanced UE may determine the HARQ resource according to the sequence indices 0, (0, 1, 2), the association index 4, and the new association set (8, 7, 6). Or, the advanced UE may determine the HARQ resource according to the sequence indices (0, 1, 2) and the new association set (8, 7, 6). In another example, the association index 4 may map to sequence index 0, and the association indices in the new association set (8, 7, 6) may map to sequence indices 1, 2 and 3, respectively. Then, the advanced UE may determine the HARQ resource according to the sequence indices 0, (1, 2, 3), the association index 4, and the new association set (8, 7, 6). Or, the advanced UE may determine the HARQ resource according to the sequence indices (1, 2, 3) and the new association set (8, 7, 6). Note that sequences of the association indices in the new association set are not limited to the above description. For example, the new association set can be (7, 8, 6), (6, 7, 8), (8, 6, 7), etc. Preferably, a resource region (e.g., physical UL control channel (PUCCH) resource region) corresponding to the association index 4 does not overlap with a resource region corresponding to the new association set (8, 7, 6). Accordingly, the HARQ resource in the resource region corresponding to the association index does not overlap with the HARQ resource in the resource region corresponding to the new association set. In addition, the determination of the HARQ resource in the subframe 2 is illustrated in the present example, those skilled in the art can readily determine the HARQ resource in other subframes according to the above description. Note that an interleaving may be performed on the new association set (8, 7, 6). Thus, the advanced UE can mitigate effects to operations (e.g., transmission and/or reception) of the legacy UE, when transmitting the HARQ feedback via the HARQ resource determined according to the above description. Collision of the HARQ resources is solved. As a result, both the advanced UE and the legacy UE can operate regularly.

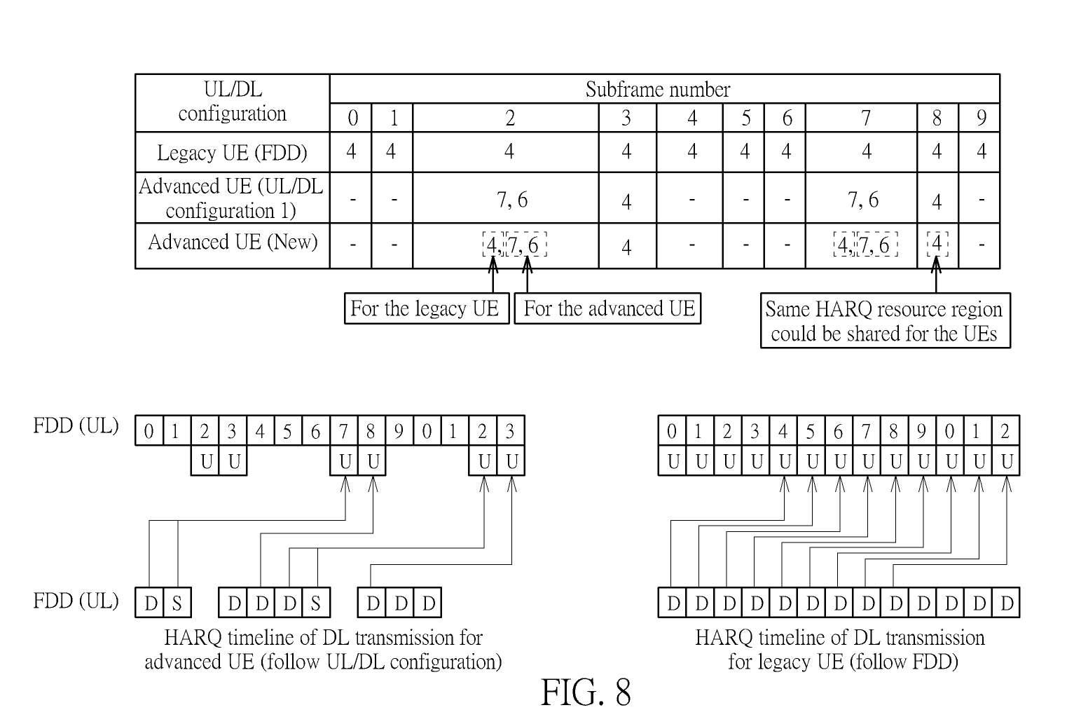

FIG. 8 is a schematic diagram of association sets of the advanced UE and the legacy UE according to an example of the present invention. In detail, the advanced UE and the legacy UE communicate with the network via a FDD carrier, and the advanced UE may be further configured with a UL/DL configuration 1 by the network for transmitting the HARQ feedback. As stated previously, the association index for the FDD carrier is 4 for all subframes. Taking the subframe 2 of the FDD carrier as an example, the association set of the UL subframe 2 which includes the association set indices 7 and 6 will be used for determining HARQ resource, when the advanced UE intends to transmit a HARQ feedback in the subframe 2 of the FDD carrier. In addition, the HARQ feedback in the subframe 2 of the present frame m may be for responding to one or more DL receptions in DL subframes 5 and 6 of the previous frame (m−1) corresponding to the association set indices 7 and 6, respectively.

According to the process 40 and the above description, the advanced UE can determine that the association index is 4 according to the operation the FDD carrier, and can determine that the new association set is (7, 6) according to the association index 4 and the association set (7, 6) of the subframe 2 of the UL/DL configuration 1. As can be seen, the new association set (7, 6) does not overlap with the association index 4. In one example, the association index 4 may map to sequence index 0, and the association indices in the new association set (7, 6) may map to sequence indices 0 and 1, respectively. Then, the advanced UE may determine the HARQ resource according to the sequence indices 0, (0, 1), the association index 4, and the new association set (7, 6). Or, the advanced UE may determine the HARQ resource according to the sequence indices (0, 1) and the new association set (7, 6). In another example, the association index 4 may map to sequence index 0, and the association indices in the new association set (7, 6) may map to sequence indices 1 and 2, respectively. Then, the advanced UE may determine the HARQ resource according to the sequence indices 0, (1, 2), the association index 4, and the new association set (7, 6). Or, the advanced UE may determine the HARQ resource according to the sequence indices (1, 2) and the new association set (7, 6). Note that sequences of the association indices in the new association set are not limited to the above description. For example, the new association set can be (6, 7). Preferably, a resource region (e.g., PUCCH resource region) corresponding to the association index 4 does not overlap with a resource region corresponding to the new association set (7, 6). Accordingly, the HARQ resource in the resource region corresponding to the association index does not overlap with the HARQ resource in the resource region corresponding to the new association set. In addition, the determination of the HARQ resource in the subframe 2 is illustrated in the present example, those skilled in the art can readily determine the HARQ resource in other subframes according to the above description. Note that an interleaving may be performed on the new association set (7, 6).

It should be noted that association indices of the subframe 8 for the advanced UE and the legacy UE are the same (i.e., 4), as shown in FIG. 8. According to the above description, the advanced UE can determine that the association index is 4 according to the operation the FDD carrier, and can determine that the new association set is a null set according to the association index 4 and the association set (4) of the subframe 8 of the UL/DL configuration 1. Accordingly, the advanced UE and the legacy UE may share the same HARQ resource region according to the same association index 4. Thus, the advanced UE can mitigate effects to operations (e.g., transmission and/or reception) of the legacy UE, when transmitting the HARQ feedback via the HARQ resource determined according to the above description. Collision of the HARQ resources is solved. As a result, both the advanced UE and the legacy UE can operate regularly.

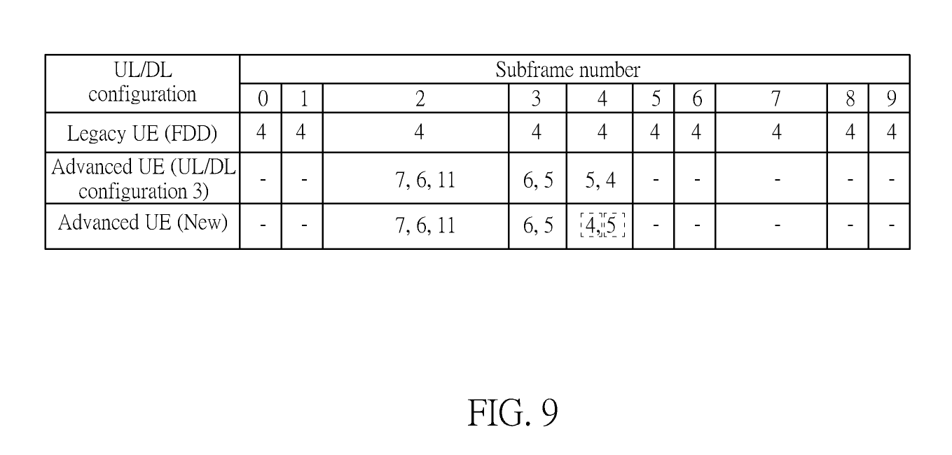

FIG. 9 is a schematic diagram of association sets of the advanced UE and the legacy UE according to an example of the present invention. In detail, the advanced UE and the legacy UE communicate with the network via a FDD carrier, and the advanced UE may be further configured with a UL/DL configuration 3 by the network for transmitting the HARQ feedback. As stated previously, the association index for the FDD carrier is 4 for all subframes. In the present example, the legacy UE is restricted to perform receptions only in the DL subframes 0 and 5. Accordingly, the legacy UE only needs to transmit the HARQ feedbacks in the UL subframes 4 and 9. Thus, the advanced UE only needs to perform the process 40 and/or the above description for the UL subframe 4, and the association sets for the UL subframes 2 and 3 of the UL/DL configuration 3 can be reused. Complexity for determining the HARQ resource can be reduced. The determination of HARQ resource in the UL subframe 4 of the FDD carrier can be referred to the previous description, and is not narrated herein.

As be stated previously, a resource region corresponding to the association index should not overlap with a resource region corresponding to the new association set. In one example, the HARQ resource n_{PUCCH,m}^{(1,p}^{₀}⁾ in the resource regions can be determined according to the following equation:

$${n}_{PUCCH , m}^{( 1 , {p}_{0} )} = \{ \begin{matrix}{n}_{CCE , m} + {N}_{PUCCH}^{( 1 )} , & m = 0 \\ \begin{matrix}( M - m ) {N}_{c} + ( m - 1 ) {N}_{c + 1} + \\ {n}_{CCE , m} + {N}_{PUCCH}^{( 1 )} + N ,\end{matrix} & m > 0\end{matrix} \qquad ( Eq . 1 )$$

wherein the first row is for determining the HARQ resource corresponding to the association index, and the second is for determining the HARQ resource corresponding to the new association set. Note that the equation (Eq. 1) is preferably used for examples where sequence indices m are (0, 1) (where M=2), (0, 1, 2) (where M=3), (0, 1, 2, 3) (where M=4), etc. n_{CCE,m} is the number of the first CCE (i.e., lowest CCE index of the corresponding DL control information (DCI)) that is transmitted in the physical DL control channel (PDCCH), wherein the corresponding DCI indicates a reception (e.g., in a PDSCH) that is to be responded by a HARQ feedback transmitted via the HARQ resource. N_{PUCCH}⁽¹⁾ is configured by a higher layer signaling. M is the number of the sequence indices, and m is the sequence index. N is used to shift the resource region of the new association set such that the resource regions of the association index and the new association set are not overlapped. The equation of (M−m)N_{c}+(m−1)N_{c+1}+n_{CCE,m} represents the effect of interleaving. The advanced UE may select a value c from (0, 1, 2, 3) to make the equations N_{c}≦n_{CCE,m}≦N_{c+1} and N_{c}=max{0, └[N_{RB}^{DL}(N_{SC}^{RB}·c−4)]/36┘} hold, where N_{SC}^{RB} is a resource block size in the frequency domain, which is expressed as a number of subcarriers, and N_{RB}^{DL} is a DL bandwidth configuration, which is expressed in units of N_{SC}^{RB}. When there are two transmit antennas at the advanced UE, the equation (Eq. 1) can be used for the first transmit antenna (P₀). The HARQ resource n_{PUCCH,m}^{(1,p}^{₁}⁾ in the resource regions for the second antenna can be determined according to the following equation:

$${n}_{PUCCH , m}^{( 1 , {p}_{1} )} = \{ \begin{matrix}{n}_{CCE , m} + {N}_{PUCCH}^{( 1 )} , & m = 0 \\ \begin{matrix}( M - m ) {N}_{c} + ( m - 1 ) {N}_{c + 1} + \\ {n}_{CCE , m} + {N}_{PUCCH}^{( 1 )} + N ,\end{matrix} & m > 0\end{matrix} . \qquad ( Eq . 2 )$$

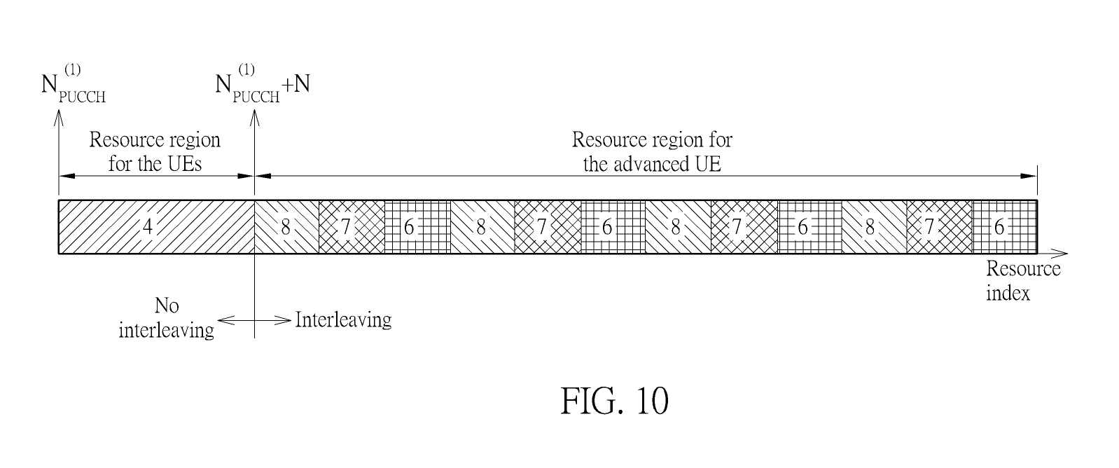

FIG. 10 is a schematic diagram of resource regions according to an example of the present invention. FIG. 10 is used as an example for illustrating the resource regions in which the HARQ resources are located. As shown in FIG. 10, a first resource region determined according to the association index 4 do not overlap with a second resource region determined according to the new association set (8, 7, 6). The start of the resource index for the first resource region is N_{PUCCH}⁽¹⁾, and the start of the resource index for the second resource region is N_{PUCCH}⁽¹⁾+N (or a new value N_{PUCCH,advanced}⁽¹⁾). In addition, the HARQ resource determined according to the association index 4 is not interleaved and is used for transmitting the HARQ feedback by the advanced UE, while the HARQ resource determined according to the new association set (8, 7, 6) is interleaved in the second resource region according to the TDD carrier and is also used for transmitting the HARQ feedback by the advanced UE.

In addition, the HARQ resource n_{PUCCH,m}^{(1,p}^{₀}⁾ in the resource regions can also be determined according to the following equations:

n_{PUCCH,m}^{(1,p}^{₀}⁾=n_{CCE,m}_{₁}+N_{PUCCH}⁽¹⁾, m₁=0, M₁=1 (1)

n_{PUCCH,m}_{₂}₁^{(1,p}^{₀}⁾=(M₂−m₂−1)N_{c}+m₂N_{c+1}+n_{CCE,m}_{₂}+N_{PUCCH}⁽¹⁾+N, m₂≧0, M₂=0 (Eq. 4)

which can be seen as another version of the equation (Eq. 1) for illustrating the cases where sequence indices are (m₁=0, m₂=0), (m₁=0, m₂=(0, 1)), (m₁=0, m₂=(0, 1, 2)), etc. The equation (Eq. 3) is for determining the HARQ resource corresponding to the association index, and the equation (Eq. 4) is for determining the HARQ resource corresponding to the new association set. Taking the sequence indices (m₁=0, m₂=(0, 1, 2)) for the subframe 2 in FIG. 7 as an example, the sequence indices can divided into 0 and (0, 1, 2), and M₁=1 and M₂=3. The association index 4 may map to sequence index 0, and the association indices in the new association set (8, 7, 6) may map to sequence indices 0, 1, 2, respectively. Then, the advanced UE may determine the HARQ resource according to the sequence indices 0, (0, 1, 2), the association index 4, and the new association set (8, 7, 6).

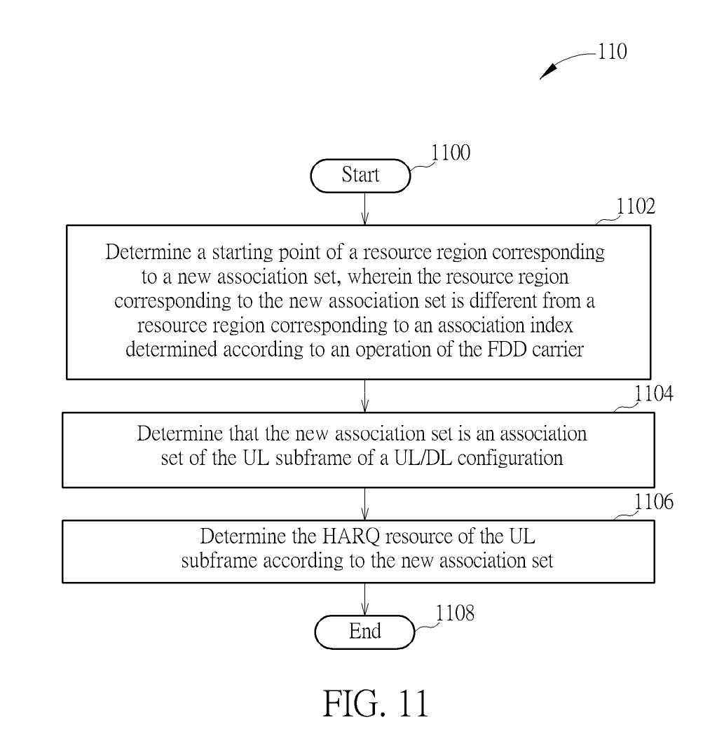

Please refer to FIG. 11, which is a flowchart of a process 110 according to an example of the present invention. The process 110 is utilized in an advanced UE shown in FIG. 2, for determining HARQ resource of a UL subframe of a FDD carrier. The process 110 may be compiled into the program code 314 and includes the following steps:

Step 1100: Start.

Step 1102: Determine a starting point of a resource region corresponding to a new association set, wherein the resource region corresponding to the new association set is different from a resource region corresponding to an association index determined according to an operation of the FDD carrier.

Step 1104: Determine that the new association set is an association set of the UL subframe of a UL/DL configuration.

Step 1106: Determine the HARQ resource of the UL subframe according to the new association set.

Step 1108: End.

According to the process 110, the advanced UE determines (e.g., receives) a starting point of a resource region corresponding to a new association set, wherein the resource region corresponding to the new association set is different from a resource region corresponding to an association index determined according to an operation of the FDD carrier. Then, the advanced UE determine that the new association set is an association set of the UL subframe of a UL/DL configuration, and determines the HARQ resource of the UL subframe according to the new association set. Thus, the advanced UE may transmit a HARQ feedback via the HARQ resource corresponding to the new association set, to respond to at least one reception performed in at least one previous DL subframe of the FDD carrier. That is, the FDD carrier may be operated by the advanced UE, or by both the advanced UE and the legacy UE. The advanced UE determines the HARQ resource according to both the UL/DL configuration and the operations of the FDD carrier, when the advanced UE intends to transmit the HARQ feedback via the FDD carrier. It should be noted that, the UL/DL configuration may correspond to a TDD carrier configured to the advanced UE, and the advanced UE may not be using the TDD carrier to communicate with the network when performing the process 40. In another example, the advanced UE may be using both the FDD carrier and the TDD carrier to communicate with the network, when performing the process 40. In another example, the UL/DL configuration may be configured by the network to the advanced UE via a higher layer signaling (e.g., RRC signaling). Thus, collision of the HARQ resources is solved, and the advanced UE can mitigate effects to operations (e.g., transmission and/or reception) of the legacy UE. As a result, both the advanced UE and the legacy UE can operate regularly.

Methods according to which the process 40 is realized are not limited to the above description. For example, the starting point of the resource region corresponding to the new association set may be at least determined according to a value configured by a higher layer signaling. In another example, the starting point of the resource region corresponding to the new association set may be at least determined according to a maximum number of control channel elements of the duplex mode. In another example, the starting point of the resource region corresponding to the new association set may be at least determined according to a total number of CCEs of another DL subframe in which a reception is performed and the reception triggers a HARQ feedback in the UL subframe. An interleaving for the new association set may be performed according to the UL/DL configuration of the TDD carrier. In addition, the legacy UE may be restricted to perform a reception in a DL subframe of the FDD carrier, and the DL subframe corresponds to the UL subframe according to the operation of the FDD carrier. That is, the legacy UE may be restricted to perform reception(s) only in certain DL subframes (e.g., the DL subframes 1-3) of the FDD carrier, such that the legacy UE only needs to transmit a corresponding UL subframe. In other words, the UL subframe(s) in which the legacy UE may transmit the HARQ feedback is controlled. Thus, the advanced UE may only need to modify its operation in the UL subframes in which the legacy UE may transmit the HARQ feedback(s). In addition, the advanced UE may determine at least one sequence index corresponding to the new association set, respectively. Then, the advanced UE may determine the HARQ resource of the UL subframe according to the at least one sequence index and the new association set.

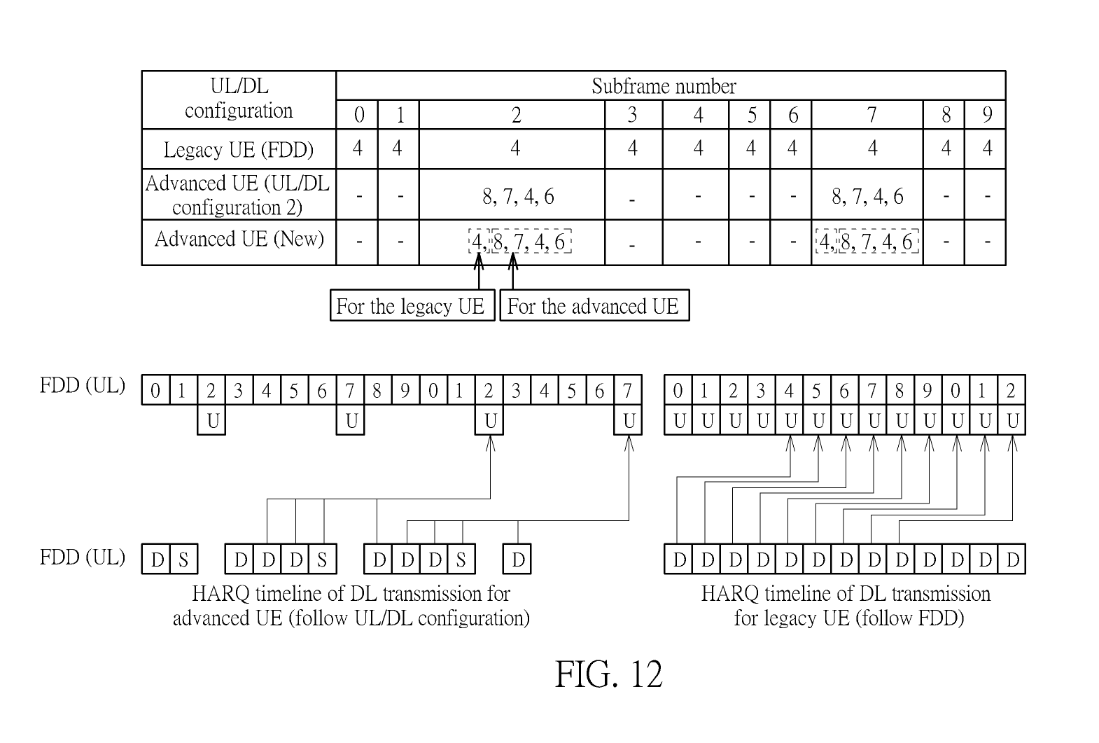

FIG. 12 is a schematic diagram of association sets of the advanced UE and the legacy UE according to an example of the present invention. In detail, the advanced UE and the legacy UE communicate with the network via a FDD carrier, and the advanced UE may be further configured with a UL/DL configuration 2 by the network. Note that the FDD rule for transmitting the HARQ feedback is that a HARQ feedback is transmitted in a subframe (n+4) for responding to a reception performed in a subframe n. Thus, the association index for the FDD carrier is 4 for all subframes. Taking the subframe 2 of the FDD carrier as an example, the association set of the UL subframe 2 which includes the association set indices 8, 7, 4 and 6 will be used for determining HARQ resource, when the advanced UE intends to transmit a HARQ feedback in the subframe 2 of the FDD carrier. In addition, the HARQ feedback in the subframe 2 of the present frame m may be for responding to one or more DL receptions in DL subframes 4, 5, 6 and 8 of the previous frame (m−1) corresponding to the association set indices 8, 7, 4 and 6, respectively.

According to the process 110 and the above description, the advanced UE can determine that the new association set is (8, 7, 4, 6) according to the association set (8, 7, 4, 6) of the UL subframe 2 of the UL/DL configuration 2, wherein a resource region (e.g., PUCCH resource region) corresponding to the new association set (8, 7, 4, 6) is different from a resource region corresponding to the association index 4. The advanced UE may receive a starting point of the resource region corresponding to the new association set from the network. That is, a resource region may be reserved for the legacy UE, such that the advanced UE will use a different resource region. Accordingly, the HARQ resource corresponding to the association index and the HARQ resource corresponding to the new association set are indifferent resource regions. In one example, the association indices in the new association set (8, 7, 4, 6) may map to sequence indices 0, 1, 2 and 3, respectively. Then, the advanced UE may determine the HARQ resource according to the sequence indices (0, 1, 2, 3) and the new association set (8, 7, 4, 6). In addition, the determination of the HARQ resource in the subframe 2 is illustrated in the present example, those skilled in the art can readily determine the HARQ resource in other subframes according to the above description. Note that an interleaving may be performed on the new association set (8, 7, 4, 6). Thus, the advanced UE can mitigate effects to operations (e.g., transmission and/or reception) of the legacy UE, when transmitting the HARQ feedback via the HARQ resource determined according to the above description. Collision of the HARQ resources is solved. As a result, both the advanced UE and the legacy UE can operate regularly.

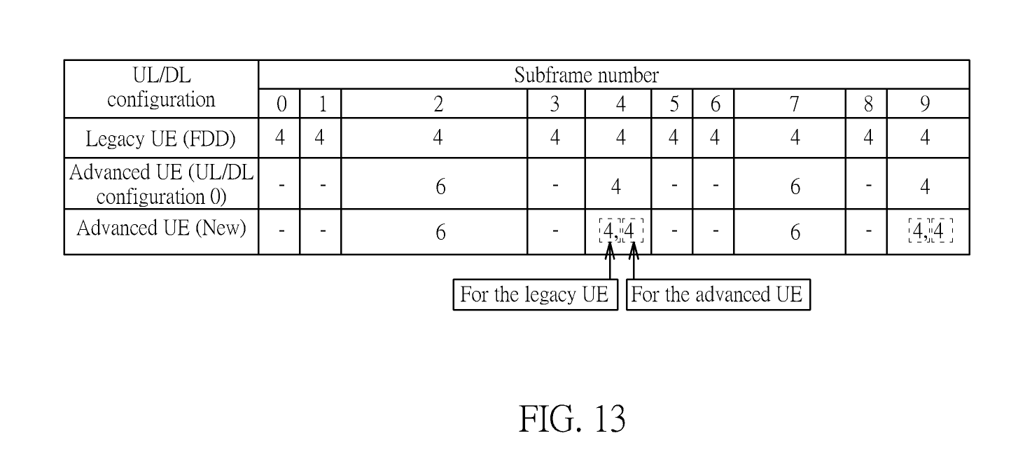

FIG. 13 is a schematic diagram of association sets of the advanced UE and the legacy UE according to an example of the present invention. In detail, the advanced UE and the legacy UE communicate with the network via a FDD carrier, and the advanced UE may be further configured with a UL/DL configuration 0 by the network. As stated previously, the association index for the FDD carrier is 4 for all subframes. In the present example, the legacy UE is restricted to perform receptions only in the DL subframes 0 and 5. Accordingly, the legacy UE only needs to transmit the HARQ feedbacks in the UL subframes 4 and 9. Thus, the advanced UE only needs to perform the process 110 and/or the above description for the UL subframes 4 and 9, and the association sets for the UL subframes 2 and 7 of the UL/DL configuration 0 can be reused. Complexity for determining the HARQ resource can be reduced. The determination of HARQ resources in the UL subframes 4 and 9 of the FDD carrier can be referred to the previous description, and is not narrated herein.

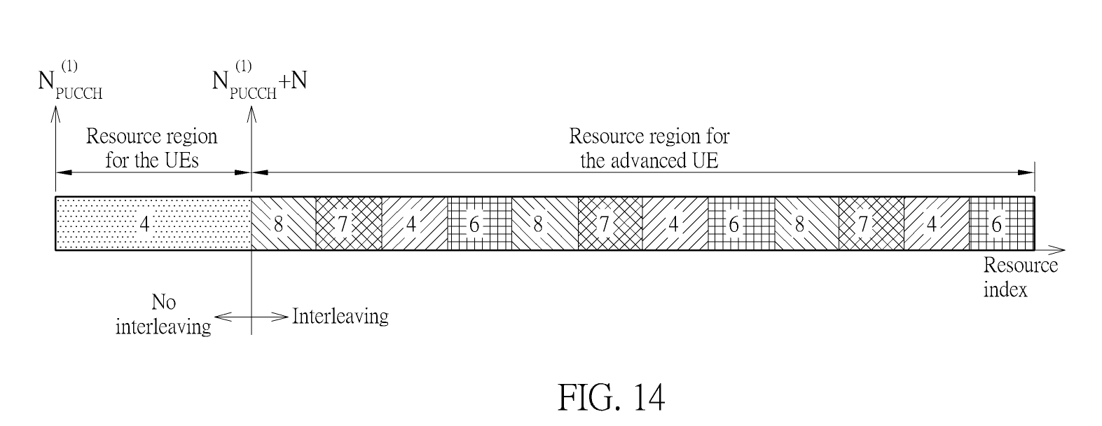

FIG. 14 is a schematic diagram of resource regions according to an example of the present invention. FIG. 14 is used as an example for illustrating the resource regions in which the HARQ resources are located. As shown in FIG. 14, a first resource region determined according to the association index 4 is different from a second resource region determined according to the new association set (8, 7, 4, 6). The start of the resource index for the first resource region is N_{PUCCH}⁽¹⁾, and the start of the resource index for the second resource region is N_{PUCCH}⁽¹⁾+N (or a new value N_{PUCCH,advanced}⁽¹⁾). In addition, the HARQ resource determined according to the association index 4 is not interleaved and is only used for transmitting the HARQ feedback by the legacy UE, while the HARQ resource determined according to the new association set (8, 7, 4, 6) is interleaved in the second resource region and is used for transmitting the HARQ feedback by the advanced UE.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means maybe the communication device 30.

Examples of the hardware may include analog circuit(s), digital circuit (s) and/or mixed circuit (s). For example, the hardware may include ASIC(s), field programmable gate array(s) (FPGA(s)), programmable logic device(s), coupled hardware components or combination thereof. In another example, the hardware may include general-purpose processor(s), microprocessor(s), controller(s), digital signal processor(s) (DSP(s)) or combination thereof.

Examples of the software may include set(s) of codes, set(s) of instructions and/or set(s) of functions retained (e.g., stored) in a storage unit, e.g., a computer-readable medium. The computer-readable medium may include SIM, ROM, flash memory, RAM, CD-ROM/DVD-ROM/BD-ROM, magnetic tape, hard disk, optical data storage device, non-volatile storage unit, or combination thereof. The computer-readable medium (e.g., storage unit) may be coupled to at least one processor internally (e.g., integrated) or externally (e.g., separated). The at least one processor which may include one or more modules may (e.g., be configured to) execute the software in the computer-readable medium.

Examples of the electronic system may include a system on chip (SoC), system in package (SiP), a computer on module (CoM), a computer program product, an apparatus, a mobile phone, a laptop, a tablet computer, an electronic book or a portable computer system, and the communication device 30.

To sum up, the present invention provides a method of handling HARQ resource for a FDD carrier. An advanced UE can mitigate effects to operations of a legacy UE, when transmitting a HARQ feedback via the HARQ resource of the FDD carrier which is also used by the legacy UE. Collision of the HARQ resources is solved. As a result, both the advanced UE and the legacy UE can operate regularly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of determining hybrid automatic repeat request (HARQ) resource of a uplink (UL) subframe of a frequency-division duplexing (FDD) carrier for an advanced communication device, the method comprising:
determining an association index according to an operation of the FDD carrier;
determining a new association set according to the association index and an association set of the UL subframe of a uplink/downlink (UL/DL) configuration; and
determining the HARQ resource of the UL subframe according to the association index and the new association set.

2. The method of claim 1, further comprising:
transmitting a HARQ feedback via the HARQ resource, to respond to at least one reception performed in at least one previous DL subframe of the FDD carrier.

3. The method of claim 1, wherein the association index does not overlap with the new association set.

4. The method of claim 1, wherein a resource region corresponding to the association index does not overlap with a resource region corresponding to the new association set.

5. The method of claim 1, wherein a starting point of a resource region corresponding to the new association set is at least determined according to a value configured by a higher layer signaling.

6. The method of claim 1, wherein a starting point of a resource region corresponding to the new association set is at least determined according to a maximum number of control channel elements of the FDD carrier.

7. The method of claim 1, wherein a starting point of a resource region corresponding to the new association set is at least determined according to a total number of control channel elements of another DL subframe in which a reception is performed and the reception triggers a HARQ feedback in the UL subframe.

8. The method of claim 1, wherein an interleaving is performed on the new association set.

9. The method of claim 1, further comprising:
determining at least one sequence index corresponding to the association index and the new association set, respectively; and
determining the HARQ resource of the UL subframe according to the at least one sequence index, the association index and the new association set.

10. The method of claim 1, further comprising:
determining at least one sequence index corresponding to the new association set, respectively; and
determining the HARQ resource of the UL subframe according to the at least one sequence index and the new association set.

11. The method of claim 10, wherein a set of the at least one sequence index corresponding to the new association set is related to one of the at least one sequence index corresponding to the association index.

12. The method of claim 1, wherein the advanced communication device determines the HARQ resource of the UL subframe according to the association index, the new association set and the number of the first control channel element (CCE) n_{CCE} of corresponding DL control information (DCI), wherein the DCI indicates a reception that is to be responded by a HARQ feedback transmitted via the HARQ resource.

13. The method of claim 1, wherein the FDD carrier is managed by a first network, and the UL/DL configuration corresponds to a time-division duplexing (TDD) carrier is managed by a second network.

14. The method of claim 1, wherein the new association set is a null set.

15. A method of determining hybrid automatic repeat request (HARQ) resource of a uplink (UL) subframe of a frequency-division duplexing (FDD) carrier for an advanced communication device, the method comprising:
determining a starting point of a resource region corresponding to a new association set, wherein the resource region corresponding to the new association set is different from a resource region corresponding to an association index determined according to an operation of the FDD carrier;
determining that the new association set is an association set of the UL subframe of a UL/downlink (UL/DL) configuration; and
determining the HARQ resource of the UL subframe according to the new association set.

16. The method of claim 15, further comprising:
transmitting a HARQ feedback via the HARQ resource, to respond to at least one reception performed in at least one previous DL subframe of the FDD carrier.

17. The method of claim 15, wherein the starting point of the resource region corresponding to the new association set is at least determined according to a value configured by a higher layer signaling.

18. The method of claim 15, wherein the starting point of the resource region corresponding to the new association set is at least determined according to a maximum number of control channel elements of the FDD carrier.

19. The method of claim 15, wherein the starting point of the resource region corresponding to the new association set is at least determined according to a total number of control channel elements of another DL subframe in which a reception is performed and the reception triggers a HARQ feedback in the UL subframe.

20. The method of claim 15, wherein an interleaving is performed on the new association set.

21. The method of claim 15, wherein the advanced communication device determines the HARQ resource of the UL subframe according to the new association set and the number of the first control channel element (CCE) n_{CCE} of corresponding DL control information (DCI), wherein the DCI indicates a reception that is to be responded by a HARQ feedback transmitted via the HARQ resource.

22. The method of claim 15, wherein the FDD carrier is managed by a first network, and the UL/DL configuration corresponds to a time-division duplexing (TDD) carrier is managed by a second network.

23. A communication device, comprising:
a storage unit for storing instructions of:
determining an association index according to an operation of the FDD carrier;
determining a new association set according to the association index and an association set of the UL subframe of a uplink/downlink (UL/DL) configuration; and
determining the HARQ resource of the UL subframe according to the association index and the new association set; and
a processing means, coupled to the storage unit, configured to execute the instructions stored in the storage unit.

24. A communication device, comprising:
a storage unit for storing instructions of:
determining a starting point of a resource region corresponding to a new association set, wherein the resource region corresponding to the new association set is different from a resource region corresponding to an association index determined according to an operation of the FDD carrier;
determining that the new association set is an association set of the UL subframe of a UL/downlink (UL/DL) configuration; and
determining the HARQ resource of the UL subframe according to the new association set; and
a processing means, coupled to the storage unit, configured to execute the instructions stored in the storage unit.
